(19) United States
(12) Patent Application Publication
(10) Pub. No.: US 2009/0094879 A1
(43) Pub. Date: Apr. 16, 2009

(54) Fishing Lure

(76) Inventor: Ivan Beck, Poulsbo, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/748,034

(22) Filed: May 14, 2007

Related U.S. Application Data
(60) Provisional application No. 60/803,615, filed on May 31, 2006.

(51) Int. Cl. A01K 85/14

(52) U.S. Cl. 43/42.51

(57) ABSTRACT

Disclosed are fishing lures formed from sheet material and having a cross-section which is generally a line. The lures are inexpensive, easy to manufacture, may receive a wide variety of surface treatments, and may be formed in a wide range of sizes. The “Mr. Humplay” lure has a slight asymmetry along the horizontal midline and a curved tail, which imparts a slight spiral to the overall shape and which produces a wobbling rotation and darting motion when pulled through the water and/or when subject to a current. The “Z-Bandit” includes fixedly oppositely turned vanes which produce body rotation and darting motion. The “Y-Belly” includes two mirror image wings connected to a triangular component and an upturned nose. The Y-Belly is more nearly symmetrical and produces a irregular wobbling and darting when pulled through the water and/or when subject to a current.

This application claims the benefit of provisional application No. 60/803,615, filed May 31, 2006.

### BACKGROUND

Fishing lures have been used for a substantial portion of human history. The disclosed invention relates generally the field of manufactured fishing lures which move, reflect light, and produce sound when pulled through the water and/or when subject to a current in the water. Such fishing lures simulate the motion of prey and/or otherwise excite predator fish, resulting in attempts by such fish to consume the fishing lure, whereupon a hook—which may be attached to, incorporated into, and/or in proximity to the lure—hooks the fish, generally through the fish's mouth. A line attached to the lure and/or hook may then be reeled in, hopefully with the fish in tow.

Artificial lures range from the very elaborate—as is demonstrated by many hand-tied fly-type lures and the many lures which incorporate multiple parts—to the more simple—as may be demonstrated by the spoon type lure, attributed to Julio T. Buel in the 19^{th} century. See for example, patent number 00014706, dated Apr. 22, 1856 and issued to J. T. Buel.

It is a goal of many fishing lure designers to design a lure which is easy to manufacture, which may be made from a wide variety of inexpensive materials, which may receive various surface treatments, which may be made in a broad range of sizes, and which is effective in catching a wide range of different fish species. Many fishing lures are also designed with one or more spinning or rotating parts, which reflect light, produce sound, and further serve to excite predator fish and/or otherwise result in attempts by such fish to consume the lure. It is believed to be desirable that the spinning or rotating motion be irregular and/or that it may change from one direction to another, thereby more closely matching the motion of living prey.

Class 43, subclass 42 defines, “Artificial or imitation bait designed to attract fish and catch or aid in catching the same. Such lures frequently look like, or when moved through the water, take on the appearance of live bait.” Indented below subclass 42 is subclass 42.5, which defines “Spoon type” lures, “the cross-section of which is a line rather than an area, and which have a curved or troughed cross-section in at least one plane.” Indented below subclass 42.5 is subclass 42.51 which includes, “Lures either in the form of a spiral or with fixed oppositely turned vanes to produce body rotation.”

The art has not demonstrated a fishing lure with the unique combination of features found in this disclosure, which features are effective at catching fish and in being manufactured in a reasonable manner.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the invention is directed to fishing lures formed from sheet material and thus having a cross-section which is generally a line, rather than an area (it being understood that the thickness of the sheet material is described as a line). Being formed from sheet material, the lures are inexpensive, easy to manufacture, may receive a wide variety of surface treatments, and may be formed in a wide range of sizes. The lures have at least one troughed cross-section. One of the lures, the “Mr. Humplay” lure, has a slight asymmetry along the horizontal midline and a curved tail, which imparts a slight spiral to the overall shape and which produces a wobbling rotation and darting motion when pulled through the water and/or when subject to a current. Another of the lures, “Z-Bandit,” includes fixedly oppositely turned vanes which produce body rotation and darting motion. Another of the lures, “Y-Belly,” includes two mirror image wings connected to a triangular component and an upturned nose. The Y-Belly is more nearly symmetrical and produces a irregular wobbling and darting when pulled through the water and/or when subject to a current.

### BRIEF DESCRIPTION OF THE DRAWINGS

FIG. 1 depicts the Mr. Humplay lure as a plan view of sheet material with markings to indicate dimension measurements, prior to final bending and forming.

FIG. 2 depicts the Mr. Humplay lure as a plan view of sheet material with the sides labeled according to the claims.

FIG. 3 depicts a perspective side view of the Mr. Humplay lure, viewed from a horizontal plain upon which the lure is resting.

FIG. 4 depicts a perspective view of the Mr. Humplay lure, generally from the top.

FIG. 5 depicts three perspective views of the Mr. Humplay lure in three sizes, generally from the side rear and slightly above the lure's highest point

FIG. 6 depicts the Z-Bandit lure as a plan view of sheet material with markings to indicate dimension measurements, prior to final bending and forming.

FIG. 7 depicts the Z-Bandit lure as a plan view of sheet material with the sides labeled according to the claims.

FIG. 8 depicts the Z-Bandit lure as a perspective view from the front and rear.

FIG. 9 depicts the Z-Bandit lure in three sizes as a perspective view from above.

FIG. 10 depicts the Z-Bandit lure as a perspective view, generally from the side.

FIG. 11 depicts various views of the Y-Belly lure.

FIG. 12 depicts two top views of the Y-Belly lure.

FIG. 13 depicts a side view of the Y-Belly lure.

FIG. 14 depicts a view of the Y-Belly lure viewed from the end to which a hook may be attached.

### DETAILED DESCRIPTION

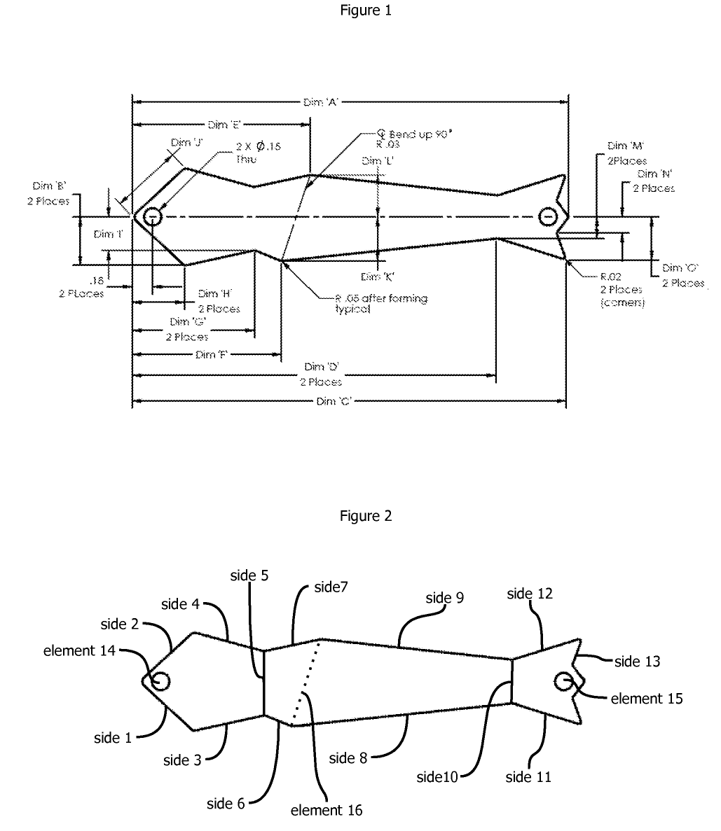

With reference to FIG. 1, following is a table with dimensions which correspond to the dimension labels in the drawings. Three sizes and example dimensions are presented, “Size A,” “Size Be” and “Size C.” However, these sizes and dimensions are presented as examples only, it being understood that the sizes are presented as examples and that the dimensions within a size and/or between sizes may vary within the range allowed by the claims. These example dimensions are presented in units of decimal inches. The number “1” is included in the following table to clarify that the reference is to the dimension label in FIG. 1. The shorthand “Dim” is used in the figure for “dimension.”

| | SIZE A | SIZE B | SIZE C |
|---|---|---|---|
| | (SMALL) | (MEDIUM) | (LARGE) |
| DIMENSION 1.A | 1.9 | 3.22 | 3.8 |
| DIMENSION 1.B | 0.22 | 0.35 | 0.43 |
| DIMENSION 1.C | 1.88 | 3.20 | 3.78 |
| DIMENSION 1.D | 1.57 | 2.77 | 3.18 |
| DIMENSION 1.E | 0.75 | 1.58 | 1.55 |
| DIMENSION 1.F | 0.62 | 1.04 | 1.30 |
| DIMENSION 1.G | 0.52 | 0.84 | 1.06 |
| DIMENSION 1.H | 0.22 | 0.35 | 0.46 |
| DIMENSION 1.I | 0.13 | 0.26 | 0.28 |
| DIMENSION 1.J | 0.1325 | 0.50 | 0.625 |
| DIMENSION 1.K | 0.21 | 0.42 | 0.38 |
| DIMENSION 1.L | 0.21 | 0.42 | 0.38 |
| DIMENSION 1.M | 0.09 | 0.19 | 0.19 |
| DIMENSION 1.N | 0.05 | 0.16 | 0.14 |
| DIMENSION 1.O | 0.19 | 0.38 | 0.38 |
| DIMENSION 1.P | 1.50 | 2.50 | 3.00 |
| DIMENSION 1.Q | 0.75 | 0.90 | 1.15 |
| DIMENSION 1.R | 0.625 | 0.875 | 0.875 |
| DIMENSION 1.S | 0.50 | 0.75 | 0.75 |
| DIMENSION 1.T | 0.125 | 0.25 | 0.375 |

FIG. 2 depicts the Mr. Humplay lure as a plan view of sheet material with the sides labeled according to the claims. As used in the claims, the distal and proximate portions of sides are relative to the front of the lure—the terminal end proximate to element 14. While this end is described here as the “front” of the lure, it is possible to use the lure with element 14 in the rear. Elements 14 and 15 may be attachment locations for attachment of fishing line, tie-off loops, eyes, hooks, swivels, and/or other lures (including other Mr. Humplay lures) or other hardware. Alternative to a hole, as is depicted in FIG. 2, a loop of material may be attached to, braised, welded and/or otherwise bonded onto, formed out of, or otherwise incorporated into an area near these locations. In a preferred embodiment, element 14 of FIG. 2 serves as an attachment location for a fishing line while element 15 of FIG. 2 serves as an attachment location for a small hoop to which a fishing hook may be attached.

FIG. 2 depicts the front portion of the Mr. Humplay lure as being comprised of a pentagon with sides 1 through 5. The middle portion of the lure is a hexagon with sides 5 through 10—side 5 being an imaginary line shared in common with the front portion. The back portion is a quadrilateral comprised of sides 10 through 13, with side 10 being an imaginary line shared in common with the middle portion. When the term approximate is used throughout this specification and the claims, it is understood to indicate plus or minus one-quarter inch. The Mr. Humplay lure has a slight asymmetry when reflected along the horizontal midline produced by the difference in size between side 6 and side 7 as well as a curved tail, which imparts a slight spiral to the overall shape and which produces a wobbling rotation when pulled through the water and/or when subject to a current.

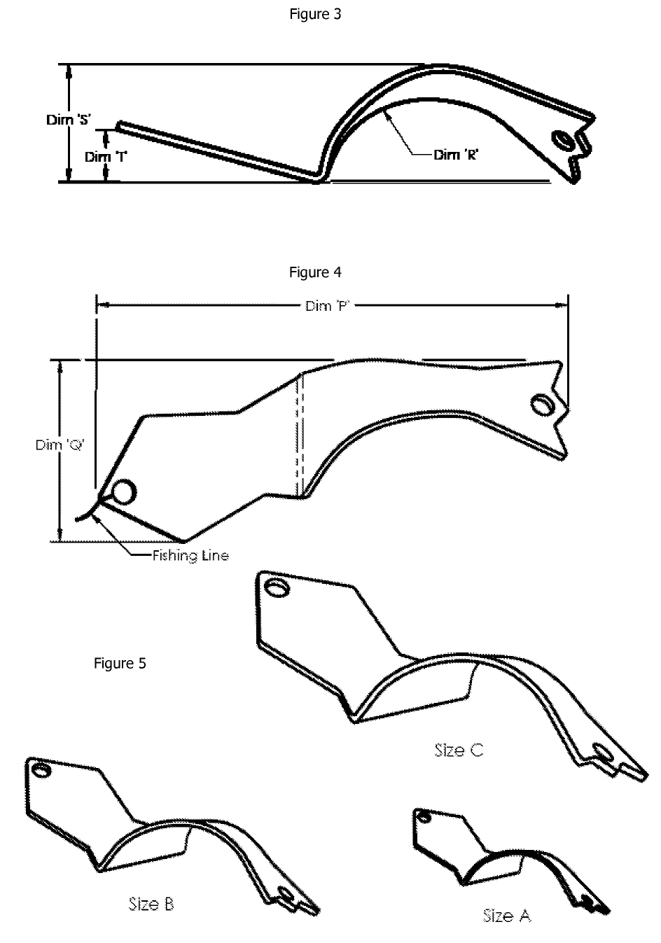

Element 16 of FIG. 2 is an imaginary line connecting the distal ends of sides 6 and 7. As depicted in FIGS. 3, 4, and 5, a bend may be formed in the sheet material at approximately this location. The bend may be approximately 90 degrees, plus or minus 15 degrees. The bend may be in either direction, relative to the plane of the sheet material. Also as depicted in FIGS. 3, 4, and 5, a generally continuous curve may be formed in the sheet material in the area comprising sides 8 and 9 and the back portion, this being referred to as the curved portion. The curved portion need not be curved continuously, but may be curved in equal or unequal steps. The curved portion must have a sufficient arc radius to bring the high-point of the curve above the level of the front end of the lure, as is shown in FIG. 3. The arc radius may differ along one side of the lure relative to the other side (these sides being relative to a horizontal centerline when the sheet material for the lure is viewed from above), as is noted in FIG. 3 and the corresponding example table entries for Dimension R, Dimension S, and Dimension T. Dimension R is depicted as being lower than Dimension S, though in another embodiment Dimension R may be equal to or higher than Dimension S.

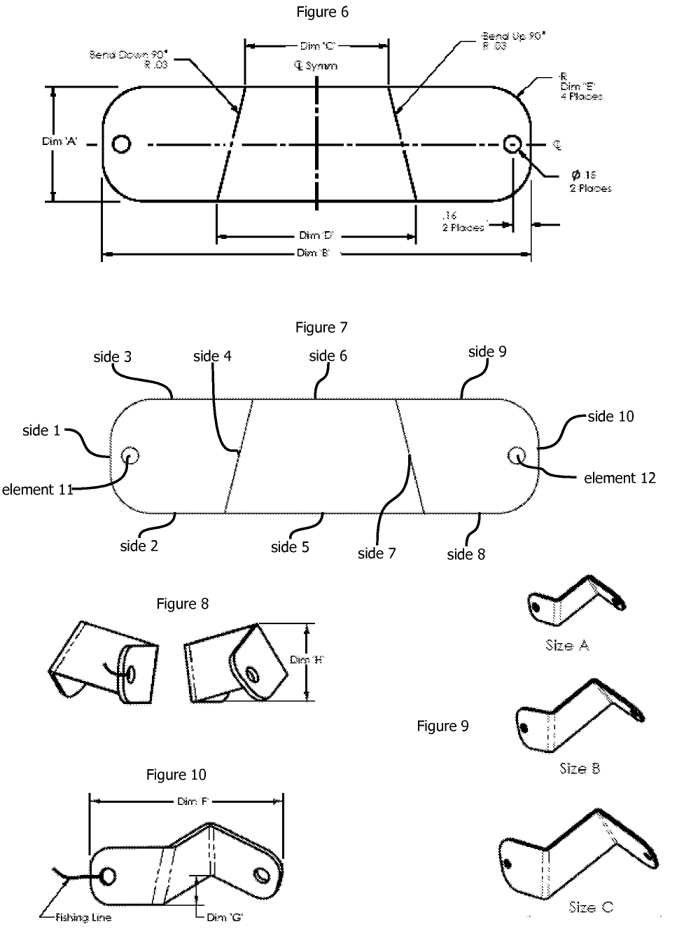

FIG. 6 depicts the Z-Bandit lure as a plan view of sheet material with markings to indicate dimension measurements, prior to final bending and forming. Following is a table with dimensions which correspond to the dimension labels in the drawings. Three sizes and example dimensions are presented, “Size A,” “Size B,” and “Size C.” However, these sizes and dimensions are presented as examples only, it being understood that the sizes are presented as examples and that the dimensions within a size and/or between sizes may vary within the range allowed by the claims, including that the plan view of the sheet material is rectangular and that each of sides 1 and 10 are shorter than the combination of sides 3, 6 and 9 or sides 2, 5, and 8. These example dimensions are presented in units of decimal inches. The number “6” is included in the following table to clarify that the reference is to the dimension label in FIG. 6. The shorthand “Dim” is used in the figure for “dimension.”

| | SIZE A | SIZE B | SIZE C |
|---|---|---|---|
| DIMENSION 6.A | 0.50 | 0.75 | 1.00 |
| DIMENSION 6.B | 2.25 | 3.00 | 3.75 |
| DIMENSION 6.C | 0.75 | 1.00 | 1.25 |
| DIMENSION 6.D | 1.00 | 1.50 | 1.75 |
| DIMENSION 6.E | 0.19 | 0.25 | 0.31 |
| DIMENSION 6.F | 1.80 | 2.30 | 2.50 |
| DIMENSION 6.G | 0.25 | 0.50 | 0.63 |
| DIMENSION 6.H | 0.68 | 1.06 | 1.30 |

FIG. 7 depicts the Z-Bandit lure as a plan view of sheet material with the sides labeled according to the claims. The Z-Bandit comprises a first portion, a middle portion, and a second portion. The first, middle, and second portions are each trapezoids; the middle portion is an isosceles trapezoid. A trapezoid is a shape with four sides and which has a pair of parallel sides. In an isosceles trapezoid, the base angles are congruent, as are the pair of non-parallel opposite sides. In FIG. 7 side 5 is the base of the isosceles trapezoid defined by sides 4, 5, 6 and 7. In FIGS. 6, 7, 8, 9, and 10, the first portion and the second portion are depicted as mirror images (reflected around a vertical centerline). However, in an embodiment, the first portion and the second portion may be of different lengths; e.g. Side 2 and 3 may be of different lengths than sides 8 and 9. The first and second portions of the Z-Bandit form fixedly oppositely turned vanes which produce body rotation.

Elements 11 and 12 may be attachment locations for attachment of fishing line, tie-off loops, eyes, hooks, swivels, and/or other lures (including other Z-Bandit lures) or other hardware. Alternative to a hole, as is depicted in FIGS. 6 through 10, a loop of material may be attached to, braised, welded and/or otherwise bonded onto, formed out of, or otherwise incorporated into an area near these locations. In a preferred embodiment, either element 11 or 12 of FIG. 7 may serve as an attachment location for a fishing line while the other element serves as an attachment location for a small hoop to which a fishing hook may be attached.

As depicted in FIGS. 8, 9, and 10, a bend may be formed in the sheet material at approximately the location of sides 4 and 7. The bend may be approximately 90 degrees, plus or minus 15 degrees. The bend may be in either direction, relative to the plane of the sheet material, provided that the two bends are in opposite directions relative to each other and the plain of the sheet material. The bends are depicted as being approximately equivalent in FIGS. 6 through 10, though in an embodiment the bends may be unequal.

The sides 1 through 13 depicted in FIG. 2 and sides 1 through 10 depicted in FIG. 7 are depicted as straight lines, though these sides may be wavy, jagged, rounded, may include other cutouts or protrusions and/or may be irregular in form, provided that the endpoint of the sides meet in approximately the same locations to form shapes according to the claim limitations. For example, and without limitation side 13 of FIG. 2 is depicted as having a regular jagged “M” or “W” form; side 13 may be formed as a straight line without deviating from the spirit of the invention or the claims. Similarly, sharp or defined corners may be rounded and rounded corners—such as the corners defined by the intersections of sides 1 and sides 2 and 3—may be sharp. Decorations—such as streamers, tassels, beads, tinsel and the like—may be attached to the basic forms depicted in the figures.

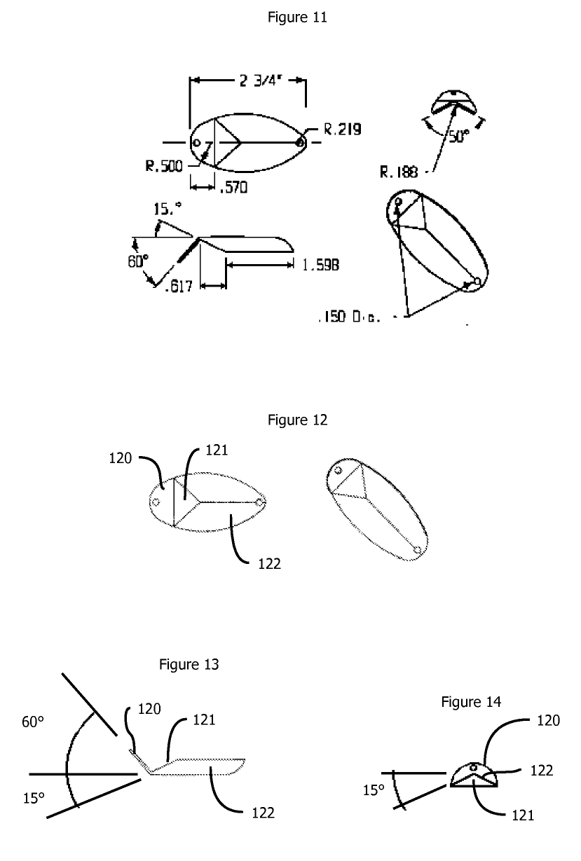

FIGS. 11 through 14 depict the Y-Belly lure. Feature 120 is a rounded portion including a hole. Feature 121 is a triangular portion. Features 122 are arc segments with a short side connected to feature 121 and long sides which connect to each other. The triangular portion is angled down by approximately 15 degrees (plus or minus 5 degrees) relative to the line formed by the intersection of the long sides of features 122, as shown in FIG. 13. The rounded portion 120 is angled up (in the direction opposite to the downward angle of feature 121) by approximately 60 degrees (plus or minus 10 degrees) relative to a line parallel to the line formed by the intersection of the long sides of features 122, as shown in FIG. 13. Features 122, when viewed from the front or back, are angled down by approximately 15 degrees (plus or minus 5 degrees) relative to a plane tangent to the intersection of the long sides of features 122, as shown in FIG. 14. Either of the holes at either end of the Y-Belly lure may accommodate a hook, line, attachment loop, and/or other hardware, including another lure. The Y-Belly lure may be produced in a wide range of sizes. When pulled through the water, the Y-Belly lure is more nearly symmetrical and has a tendency to spin and weave in an irregular manner.

The figures depict sheet material which may be cut, stamped, and/or bent and manipulated according to conventional manufacturing processes; however, in embodiments the lures may be formed in 3-dimensional molds.

The lures may comprise iron, steel, aluminum, nickel, zinc, copper, chromium, gold, silver, titanium, metal alloys, plastic, cellulose-based plastics, polystyrene, PVC, nylon, rubber, acrylic, polyethylene, ceramic, hardened polymer resins, hardened polymer resins plus cloth, fiberglass cloth or fiberglass mat, stone, stone powder and resin. Surface treatments may include, without limitation, painting, decals, stickers, plating, electroplating, oxidation, polishing, brushing, scratching and similar. Surface treatment may include regular or irregular solids, stripes, spots, geometric shapes, and/or irregular shapes. Surface treatment may be applied to before, during, or after preparation of the lures. It should be understood that references to a “hook” and/or “hooks” throughout refer to single, double, and/or treble hooks, with or without barbs and/or bends or other features in the hook shank.

1: A fishing lure with a cross-section generally comprising a line, a front portion, a back portion, and a middle portion connecting the front and the back portions, wherein with the flat pattern for the fishing lure is formed from sheet material and wherein the portions of the flat pattern are as follows:
the front portion approximately forms a pentagon comprising sides 1, 2, 3, 4, and 5, wherein
sides 1 and 2 are of approximately equal length and connect to form the front of the lure,
the distal end of side 1 connects with the proximate end of side 3,
the distal end of side 2 connects with the proximate end of side 4,
sides 3 and 4 are approximately opposite and approximately of equal length,
the distal ends of sides 3 and 4 connect with the ends of side 5, and
side 5 forms the distal end of the front portion, and which side is perpendicular to a first imaginary centerline drawn from the front of the lure through the middle of side 5;
the middle portion is a hexagon comprising sides 5, 6, 7, 8, 9, and 10, wherein
side 5 is also side 5 of the front portion,
the proximate ends of sides 6 and 7 connect to the ends of side 5,
the distal end of side 6 connects with the proximate end of side 8,
the distal end of side 7 connects with the proximate end of side 9,
sides 6 and 7 are approximately opposite and are of unequal length,
sides 8 and 9 are approximately opposite and are of unequal length,
the distal ends of sides 8 and 9 connect with the ends of side 10, and
side 10 forms the distal end of the middle portion, and which side is perpendicular to the first imaginary centerline drawn from the front of the lure through the middle of side 5 and extended through the middle of side 10;
where the back portion is a quadrilateral comprising sides 10, 11, 12, and 13, wherein
side 10 is also side 10 of the middle portion,
the proximate ends of sides 11 and 12 connect to the ends of side 10,
the distal end of sides 11 and 12 are connected to the ends of side 13;
where sides 8 and 9 of the middle portion and the back portion are referred to as the curved portion;
where an approximately 90 degree bend is formed in the sheet material along a second imaginary line connecting the distal ends of sides 6 and 7; and
where an approximately continuous curve is formed in the sheet material comprising the curved portion such that at least one of the ends of side 13 contacts an imaginary plane extending outward from the second imaginary line, wherein the maximum height of the curved portion above the imaginary plane is greater than the maximum height of the front end of the lure above the imaginary plane.

2: The lure according to claim 1 where the sheet material is selected from a group comprising iron, steel, aluminum, nickel, zinc, copper, chromium, gold, silver, titanium, metal alloys, plastic, cellulose-based plastics, polystyrene, PVC, nylon, rubber, acrylic, polyethylene, ceramic, hardened polymer resins, hardened polymer resins plus cloth, fiberglass cloth or fiberglass mat, stone, stone powder and resin.

3: The lure according to claim 1 further comprising a surface treatment.

4: The lure according to claim 1 further comprising an attachment location for attaching a fishing line to the lure.

5: The attachment location according to claim 4 where the attachment location is a hole located between sides 1 and 2.

6: The attachment location according to claim 4 where the attachment location is a loop attached to the front portion.

7: The lure according to claim 1 further comprising a hole located between sides 11 and 12.

8: The lure according to claim 1 where at least one of the sides is jagged.

9: The jagged side according to claim 8 where the jagged side is side 13.

10: The jagged side 13 according to claim 9 where the most distal point of the jagged side 13 is further from a line perpendicular to the front tip of the lure than at least one of the ends of side 13.

11: A fishing lure with a cross-section generally comprising a line, a first portion, a second portion, and a middle portion connecting the first and the second portions, wherein with the flat pattern for the fishing lure is formed from sheet material and wherein the portions of the flat pattern are as follows:
the first, middle, and second portions are each trapezoids;
the middle portion is an isosceles trapezoid;
the first portion comprises sides 1, 2, 3, and 4, wherein
sides 2 and 3 are parallel and of unequal length;
the middle portion comprises sides 4, 5, 6, and 7, wherein
side 4 is side 4 of the first portion,
sides 5 and 6 are parallel,
sides 4 and 7 are not parallel;
the second portion comprises sides 7, 8, 9, and 10
side 7 is side 7 of the middle portion,
sides 8 and 9 are parallel and of unequal length;
the connected sides 2, 5, and 8 are equal in length and parallel to the connected sides 3, 6, and 9;
side 1 and 10 are parallel and of equal length;
either of connected sides 2, 5, and 8 or connected sides 3, 6, and 9 are longer than either of sides 1 or 10;
where a bend is formed in the sheet material along each of lines 4 and 7 and where these bends are in opposite directions relative to the plain of the flat pattern.

12: The lure according to claim 10 where the first portion and the second portion are mirror images.

13: The lure according to claim 10 where the bends are approximately 90 degrees.

14: The lure according to claim 10 where the sheet material is selected from a group comprising iron, steel, aluminum, nickel, zinc, copper, chromium, gold, silver, titanium, metal alloys, plastic, cellulose-based plastics, polystyrene, PVC, nylon, rubber, acrylic, polyethylene, ceramic, hardened polymer resins, hardened polymer resins plus cloth, fiberglass cloth or fiberglass mat, stone, stone powder and resin.

15: The lure according to claim 10 where the corners of the first and second portions are rounded.

16: The lure according to claim 10 further comprising an attachment location for attaching a fishing line to the lure.

17: The attachment point according to claim 16 where the attachment location is a hole located in the first end and/or the second end.

18: The attachment location according to claim 16 where the attachment location is a loop attached to the first end and/or the second end.

19: The lure according to claim 10 further comprising a surface treatment.

20: The lure according to claim 10 where the bends are not equal.
